(19) United States
(12) Patent Application Publication
(10) Pub. No.: US 2004/0103012 A1
(43) Pub. Date: May 27, 2004

(54) Method for automated insurance pricing and renewal notification

(75) Inventors: Urs Nussbaum, Zollikon (CH); Craig Zottola, Hopewell Junction, NY (US)

Correspondence Address: DARBY & DARBY P.C., P. O. BOX 5257, NEW YORK, NY, 10150-5257, US

(73) Assignee: Swiss Reinsurance Company, Zurich (CH)

(21) Appl. No.: 10/704,256

(22) Filed: Nov. 6, 2003

Related U.S. Application Data
(60) Provisional application No. 60/428,730, filed on Nov. 22, 2002.

(51) Int. Cl. G06F 17/60

(52) U.S. Cl. 705/4

(57) ABSTRACT

Insurance renewal is facilitated in a computerized system by filtering information on expiring insurance contacts to determine which contracts qualify for automatic pricing. In response to a signal from a client, a portfolio of the client's expiring contracts is generated and the client is provided with a display of the portfolio. The portfolio includes at least an identification of the client's expiring contracts, the status of each contract and, a field for renewal pricing. An expiring contract identified in the portfolio is renewed upon the provision of a renewal instruction from the client.

This application claims the benefit of U.S. Provisional Application Serial No. 60/428,730 filed Nov. 22, 2002, which is hereby incorporated by reference in its entirety.

### FIELD

Communications and transactions pertaining to insurance.

### BACKGROUND

Reinsurance indemnifies an insurance company, known in the industry as cedent, against all or part of the loss sustained under an insurance policy it issued on a risk. The term “risk” refers to the property or liability being insured. An insurance company may be vulnerable in the event of a particular disaster affecting the risk underlying many policies. To spread its risks, among other reasons, the insurance company may contract with a reinsurer to assume some risk of the insured loss.

There are various parties in this relationship: the policy holders who purchase insurance from the insurance company; the reinsurance company that reduces the risk of loss on the policies issued by the insurance company; and the insurance company in the middle having relationships with the policy holders and one or more reinsurance companies. Sometimes, the insurance company is represented by a reinsurance broker who facilitates the process of finding a reinsurance company agreeable to indemnify certain risks. An exchange or data hub is an environment for insurance companies and reinsurers to interact. Typically, the insurance company has to keep track of many policies and contracts, which can become quite complicated and cumbersome.

In current practice, the insurance company or reinsurance broker initiates transactions, directly or through an exchange with the reinsurance company. In this context the insurance company or reinsurance broker acts as a “client” and the reinsurance company or underwriter acts as a “provider.” As with many businesses, the client conducts transactions and the provider issues a bill or invoice to the client for payment. If there is an adjustment of some underlying policy, the client contacts the appropriate provider to update and/or adjust the corresponding reinsurance contract. If the reinsurance contract is to be changed or renewed, the client contacts the appropriate provider with the request to change or renew. The reinsurance company is passive, reacting to requests from the insurance company. Contracts are handled on an individual basis by the reinsurer and insurance company. Further, the insurance company or broker and the reinsurer duplicate a significant amount of information regarding the reinsurance contracts.

The present invention alleviates some of the burden of maintaining the status of the policies and contracts that are subject to the transactions between the providers and clients. Furthermore the present invention is a method for the provider to service the client efficiently in renewing contracts. The term “provider” here and throughout refers to the reinsurance company, underwriter, or other entity that provides products or services and “client” here and throughout refers to the insurance company, reinsurance broker, or other entity that contracts to receive the products or services.

### SUMMARY OF INVENTION

The present invention is a method and system for facilitating insurance renewal using computer communication or a network for transmitting information between the provider or server and the client or clients. A source system or database component is queried to identify those contracts, e.g., reinsurance contracts, that are due to expire within the predetermined period. The query results are filtered to determine which expiring contracts qualify for automatic pricing. A portfolio is generated identifying the client's expiring contracts and indicating which of the expiring contracts qualify for automatic pricing. When the client accesses its portfolio, the client is provided with the options, of updating contract information, requesting a premium quote, or renewing a quoted expiring contract, among others. The client may select any of the identified contracts to receive further details of the selected contract.

For contracts that qualify for automatic pricing, the renewal premium quote is computed in real-time based on one or more parameters pertaining to the contract and included in the portfolio. The client renews the contract by accepting the quoted premium. The renewed contract is then certificated or bound in real-time. If the client wants the contract to expire, the client indicates non-renewal for the contract. For contracts that do not qualify for automatic pricing, after the provider determines the premium quote, it is included in the portfolio. The client can then renew the contract for the quoted premium, allow it to expire, request communication from the provider, or select another transaction from the portfolio access.

### BRIEF DESCRIPTION OF DRAWINGS

FIG. 1 shows a block diagram of the system according to the preferred embodiment of the invention;

FIG. 2 shows a flowchart of the method according to the preferred embodiment;

FIG. 3 shows a sample portfolio display of expiring contracts for a client according to the preferred embodiment; and

FIG. 4 shows a sample expiring contract profile display according to the preferred embodiment.

### DETAILED DESCRIPTION OF PREFERRED EMBODIMENT

In the preferred embodiment described below, the subject matter is reinsurance and the interactions are between the reinsurer and insurance company or broker. However the invention applies to contracts and interactions between providers and clients. In this embodiment, the reinsurer is both a party to the contract and the entity managing the invention method and system. However, the invention may be performed or managed by an entity separate from the reinsurer. For example, an exchange or third party may maintain the system infrastructure and provide the application-based service to subscribed providers and clients.

Facultative reinsurance agreements are particularly suitable to benefit from this invention because the contract parameters are qualitative in nature. Facultative reinsurance contracts cover individual underlying policies on an individual basis for particular risk exposure. In contrast treaty reinsurance contracts cover a class of risks such as the insurance company's workers' compensation portfolio. However, the present invention is applicable to other insurance agreements or contracts, including but not limited to property, casualty, liability, engineering, and life. The term insurance is used throughout to encompass at least insurance and reinsurance.

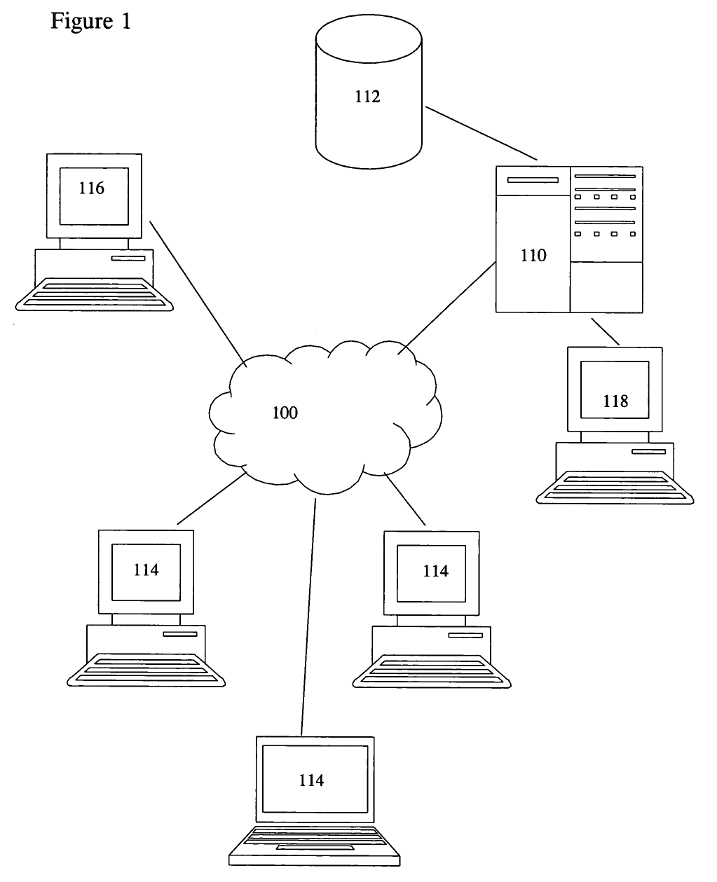

The method is implemented by a computer software application (executable computer program) operating within the network computer system according to the preferred embodiment. Referring to FIG. 1, the application operates on a server (or servers) 110 having access to the source system or database component 112 and a computer network or communication system. For example, an Internet 100 or online service is used to provide efficient communication between the application server(s) 110, the clients' computer or workstations (“client computer”) 114 and the providers' computer or workstations 116. A website or other means of access is established as a portal to the application through the network or communication system. Clients and providers use standard browsers to access the portal. The application is web-enabled (or otherwise activated) creating an interactive environment for clients and providers and coordinating with the source system. The application can operate substantially continuously as is known in the computing industry, so that information may be communicated and transactions performed at any time. The application or database may be down occasionally (or periodically) for maintenance, archive, or other practical considerations. The database may reside on the same server as the application or a separate server or computer. The database may be connected directly to the server, as illustrated, of indirectly through the network. The server and provider computer may be the same or separate computer, collectively referred to as the “provider server.” A provider workstation 118 may be directly connected to the server in addition to or instead of the network connection such as provider workstation 116.

The application notifies insurance companies of their reinsurance contracts that will expire within some predetermined period, which may be selectable, and presents the information in a portfolio format. For qualifying reinsurance contracts, the insurance company can renew the expiring contract for a quoted premium directly through the automated system.

The source system manages all the information about the reinsurance contracts referred to herein as parameters. For each reinsurance contract, the database stores, for example, the following parameters: reinsurance contract number (risk number), effective period and/or expiration date, premium, total insured value, layer (coverage amount), limit, retention, deductibles, the name of the insurance company (cedent), the policy number for the policy issued by the cedent to the insured, the name of the insured, perils, geographic location of the insured property, insured value of the insured property, construction of the insured property, occupancy of the insured property, protection for the insured property, and status of the reinsurance contract.

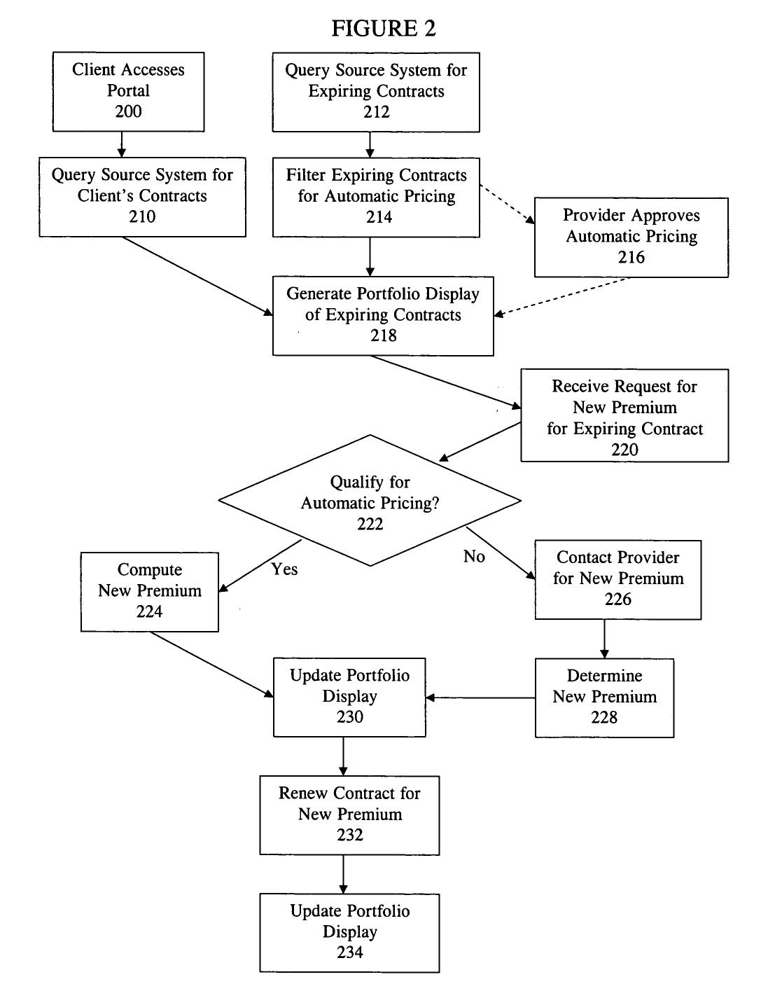

Various features of the invention according to the preferred embodiment are described with reference to FIG. 2. One feature is that the client can remotely access and transaction on its contracts through the portal connection. This feature enhances the client's control and flexibility in handling its contracts. Typically, this arrangement is implemented by a subscription service where the client has an account, username and password and the client's contracts are associated with the client's account as is known in the computing industry. As illustrated, at step 200 the client accesses its account through the portal. At step 210, the application queries the source system for the client's contracts, i.e., the contracts associated with the client's account. A portfolio display of the client's contracts is generated based on the query as described below with reference to step 218.

Another feature of the preferred embodiment is that all the clients' contracts (typically for one provider) are managed collectively based on the expiration dates. At step 212, the application queries the source system for the reinsurance contracts that will expire within the predetermined period. For example if the predetermined period is forty-five days, then the query will identify all reinsurance contracts that will expire within the next forty-five days from the date of the query. The provider (or its system administrator) specifies or selects the predetermined period.

In the preferred embodiment, the query is performed periodically independent of the client's access. For example, the query may be triggered by a timer such that query is repeated periodically such as weekly, biweekly, monthly on a particular day of the month, etc. The query is typically database-wide capturing all expiring contracts regardless of the client. In a another embodiment, the query is triggered by a signal from the client or provider indicating a request for particular contracts or expiring contracts. For example, the query may be limited to a specific client or group of clients based on contract parameters such as region, or underwriter, etc. In further embodiment, the query is triggered by the client's account access, i.e., when a connection is established between the client's computer workstation and the server. (Here and throughout, the various embodiments described may be concurrently operative, i.e. the application may be designed to include more than one way of performing a feature.)

At step 214, the query results (from step 212) are filtered to identify whether each contract qualifies for automatic pricing. Automatic pricing means that the contract falls within certain normal characteristics and therefore may be priced without additional consideration. Filtering the normal characteristics is performed based on one or more of the contract parameters. The filter may be configured to disqualify a contract that covers an unusual risk or has some particular feature. For example, the reinsurer may want contracts with high insured-value or a high premium to be reviewed individually by the provider underwriter. The filter then is a threshold on the appropriate contract parameter, e.g., total insured value or premium. The filter may be compound such as the following conditions for qualifying a contact for automatic pricing: (a) the property is in region A and the premium is below B; (b) the property occupancy is X, Y, or Z; or (c) the total insured value is more than W. For automatically priced contracts, a premium is calculated based on a formula and the cedent can renew the contract for the automatically determined premium by communicating directly with the system, without personal involvement from the reinsurer.

If the contract does not qualify for automatic pricing, the contract may be priced manually. The term “manual” as applied to pricing denotes that the contract did not qualify for automatic pricing. For manual pricing, the provider may use automated tools to assist in computing the premium. The provider may review all or some of the contract parameters and/or consult with the client as part of the process of determining the premium. By definition of manual pricing, there is no inherent limit on when the manual pricing is performed, except that obviously a contract designated for manual pricing cannot be renewed before a new premium is determined. Manual pricing is further described with reference to steps 226 and 228 according to the preferred embodiment. The filter may also be configured to designate contracts with certain characteristics as non-renewable.

The results of the filtering step 214 are stored in the source system. The appropriate contract parameter is updated with the resulting designation: automatic, manual, and non-renewable.

In a further embodiment, step 216 the application provides the filtered query results to the provider for approval of the filtering into automatic and manual pricing before generating the portfolio display. The dotted arrows to and from step 216 indicate that this approval step is a further embodiment. In the approval process, the provider has various options, for example: approve the designation (automatic pricing, manual pricing, or non-renewable) as determined by the filter; change the designation, e.g., from automatic to manual pricing; or change the designation from automatic or manual to non-renewable. If the designation is changed, the source system is updated accordingly. The source system may also store the stats indicating that the contract has been approved.

In this further embodiment, if the source system handles more than one underwriter associated with the reinsurance company, the query results are sorted and distributed to the appropriate underwriter. Each underwriter for the reinsurer receives the information about those identified expiring contracts that it underwrites. For convenience, the underwriter initially receives a summary of resulting expiring contracts, i.e., the basic parameters about each contract, including whether the contract qualifies for automatic pricing. Basic parameters include, for example, name of insured, the policy number, the total insured value, and the expiring premium. Upon request, the underwriter may access further information about any of its contracts. Once the designations for the expiring contracts have been approved or revised and thereby approved by the provider, the portfolio display for the client is generated at step 218.

In the preferred embodiment, the client receives or accesses the portfolio display by “logging on” to its account through the portal, substantially at any time. However, it is also useful for the client to be notified that an updated portfolio is available. For example, the application may send an e-mail, page a beeper or disseminate some other communication to the client. The communication may be merely stating that the updated portfolio is available through portal access or include substantive information including all or part of the portfolio display generated at step 218. Some type of notification may be particularly useful, in the further embodiment, where the filtering step 214 is subject to approval (step 216). For the embodiment where the querying and filtering steps (212-214) are performed periodically, the notification may be configured for distribution to clients who do not access their accounts through the portal within some period after the filtering is performed.

Continuing with the description of the preferred embodiment, at step 218, a portfolio display is generated based on the various query results. as indicated above, in the preferred embodiment, the query for expiring contracts (step 212) and filtering (step 214) is performed periodically. Thus, when a client accesses its account through the portal (step 200) triggering a query for the contracts associated with the client (step 210), the generated portfolio display (at step 218) takes into account whether the expiring contract has been designated for automatic pricing, manual pricing, or non-renewal. Alternatively or in addition, the filtering step (214) may be performed on the results of the query at step 210 (for the client's contracts expiring within the predetermined period) triggered by the client access at step 200.

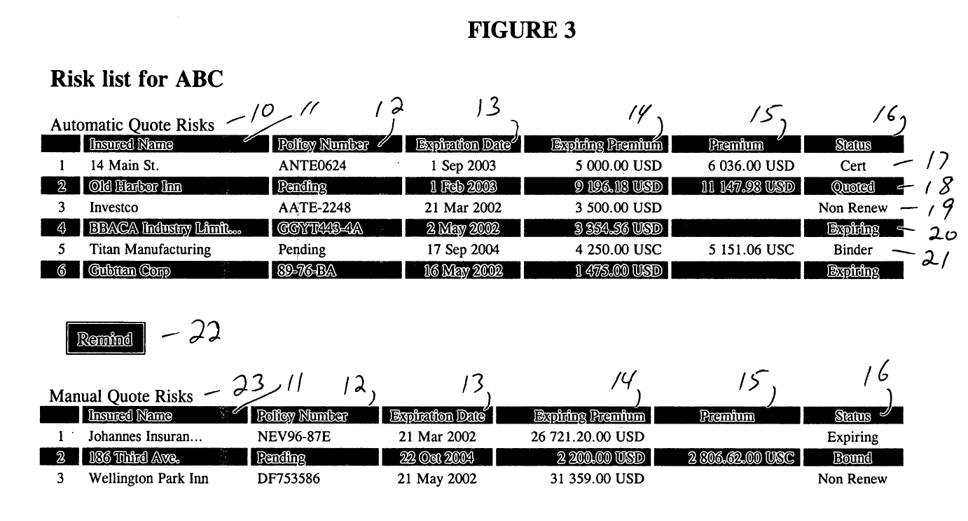

As illustrated in FIG. 3, the portfolio display includes a profile for each expiring contract including (1) a field that identifies the contract and (2) a field that indicates the status 16 of the contract. The portfolio also indicates whether the contracts qualify for automatic pricing 10 or manual 23. This indication may be achieved by separately listing the automatic pricing contracts from the manual pricing contracts, as illustrated. The automatic versus manual pricing may be indicated in other ways, such as a field in the profile for each contract. The contract is identified, for example, by the name of the insured 11 or policy number 12. The profile also includes a field for the new premium 15 which would apply if the contract were renewed. The profile may include other fields such as the expiration date 13 and expiring premium 14. For each contract, the information in the fields is based on the corresponding contract parameters. If the new premium has not yet been computed, the field for the new premium 15 is empty. When the new premium is computed, either automatically or manually depending on its qualifications, the profile is updated and new premium is displayed at field 15 of the profile.

For contracts that qualify for automatic or manual pricing, the status 16 of the contract may be, for example, expiring 20, quoted 18, certificate 17, binder 21, and non-renew 19. Expiring status 21 means that the contract is due to expire within the predetermined period however the new premium has not yet been determined. Quoted status 18 means that a premium to renew the contract was computed (automatically or otherwise). After an agreement is reached between the cedent and reinsurer on the. premium to renew the contract, and the underlying insurance policy is made available by the cedent to the reinsurer, a certificate number is issued by the reinsurer (to comply with insurance regulations); thus the certificate status 17. To accommodate the regulations, a interim status is introduced called binder. When the cedent is ready to accept the quoted premium, the cedent can finalize the renewal with a binder number, thus the binder status 21, which represents the renewed insurance contract while waiting for the certificate to be issued. When the reinsurer replaces the binder with a certificate, the contract status changes from binder 21 to certificate 17. From the perspective of the cedent, binder is as final as the certificate and the renewal transaction is complete. If the client does not want to perform any transaction on the listed contracts, the client may request a reminder by selecting remind 22 as illustrated in FIG. 2.

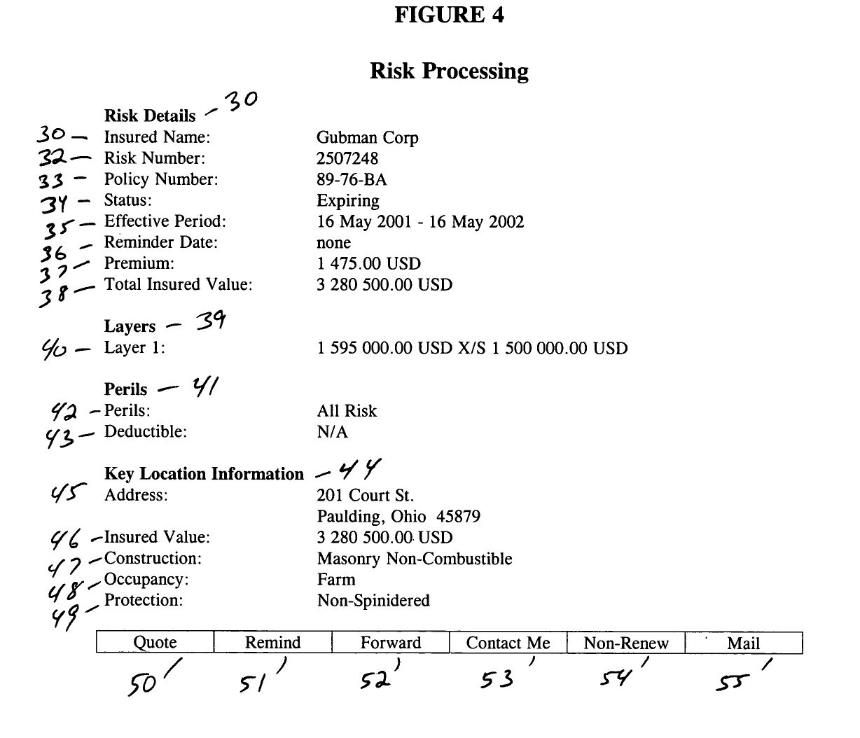

From the portfolio display, when the client selects one of the contracts, more details of the selected contract are presented in the profile display. As illustrated in FIG. 4, contract details in the profile display include for example, risk details 30, layers 39, perils 41, and location information 44. Risk details refers to contract parameters such as the insured's name 31, risk number 32, policy number 33, status 34, effective period 35, reminder date 36 (if any), premium 36, and total insured value 38. Layer 40 refers to the coverage amount in excess of retention. Perils refers to the risk 42 and deductibles 43. Location information includes for example, address 45, insured value 46, construction 47 (e.g. what the property is made of), occupancy 48 (e.g., what the property is used for), and protection 49 (or precaution that reduce the chance of peril).

From the detailed profile display (illustrated in FIG. 4) or by scrolling through nested displays, the client had various options for transactions on the contract. Depending on the status of the contract, the client may have the following options: update contract information, request a premium quote 50, renew a contract at the quoted premiums by binder or certificate, request a reminder 51, forward contract details to someone else 52, request that the provider contact the client 53, designate a contract as non-renewable 54, and print contract details 55.

Referring again to FIG. 2, at step 220, the client requests a quote for a premium for one of the profiled expiring contracts. The client is prompted to confirm or update select contract details that may impact the contract's qualification of automatic pricing. For example select contract details may include occupancy, protection, catastrophe deductible, perils, whether there were any losses over a predetermined threshold, whether any other insurance or reinsurance coverage applies to the risk, and the current total insured value. In a further embodiment, the client may update the contract details at any time, however certain changes may trigger a change in status from automatic pricing to manual or if a premium was already quoted, adjusting contract details may void the premium quote and require a recalculation. Updated or adjusted contract details are stored in the source system by updating the appropriate parameters.

At step 222, the application checks and confirms whether the contract qualifies for automatic pricing. If there were no changes in the contract details that affect qualification for automatic pricing, the application checks the indication stored in the source system associated with the contract as a result of the filtering step 214 or in the further embodiment as a result of the approval step 216. If there were changes in the contract details that affect qualification for automatic pricing, then the application determines the affect.

If the contract still qualifies for automatic pricing, at step 224, the application computes a premium based on the contract details in accordance with a predetermined formula. If the client updated any of the contract details that affect the premium, the updated information is used to compute the premium quote. The premium is computed and at step 230 the updated portfolio display including the premium quote is provided to the client in real time in response to the client's request at step 220. The source system is updated with the premium quote.

If the contract does not qualify for automatic pricing, at step 226, the request for a premium quote is directed (and communicated) to the provider. At step 228 the provider determines the premium quote and the source system is updated. Thereafter the portfolio display is updated at step 230. Due to the unknown amount of time for the provider to determine the premium quote, the client typically disconnects from the portal. Upon subsequent connection the updated portfolio display will reflect the premium quote. Also as described above, the client may be notified by e-mail, phone, or other communication when the premium is available at which time the client may reestablish the connection through the portal. Under appropriate conditions (as determined by the provider), the provider may determine a premium quote for a manual pricing contract at or about the time of performing the filtering (214) or approval (216) steps. Thus premium may be provided in the portfolio display generated at step 218 or if the contract details remain unchanged after the request at step 220, the premium may be provided in the updated portfolio display presented in real time (bypassing steps 226 and 228).

The premium for renewing the contract typically varies according to market forces as well as changes in the contract details. The reinsurer specifies modifiers to reflect these factors. The premium quote is then computed by adding the product of the expiring premium and the one or more modifiers. For example, if inflation is 7%, the modifier for all contracts may be 0.07 to match inflation, or 0.10 to produce profits above inflation.. For an example of a modifier based on contract details, if a penthouse was added to a three story building, the modifier may be 0.25 which would raise the premium by 25%. If both modifiers were applied, the premium would be raised 32%. Another example is if the reinsurer perceives an increased risk in a geographic region, the modifier for this geographic region may be 0.12. If this modifier was combined with the inflation modifier, the premium would be raised 19%. The reinsure may establish rules to reflect the conditions that set the modifiers. In the alternative, the reinsure can set the modifiers directly.

After a premium quote is provided (whether computed automatically or manually), at step 232, the client can accepts the quoted premium by selecting certificate or bind, thus renewing the contract. The renewal is performed directly in response to the client's selection based on the portfolio and profile displays. At step 234, the portfolio display is updated as well as the source system.

1. A method for insurance renewal notification comprising the steps of:
(a) querying a source system containing information about client contracts for contracts expiring within a predetermined period for a client;
(b) for an expiring contract, determining whether the contract qualifies for automatic pricing based on a first parameter included in the information; and
(c) generating a notification for the client of the expiring contract that qualifies for automatic pricing

2. The method of claim 1 wherein the querying step is performed automatically on a periodic basis.

3. The method of claim 1 further comprising the steps of:
(a) upon receiving a request from the client, determining a premium quote for a selected one of the contracts based on a second parameter in the information; and
(b) producing the premium quote for the client.

4. The method of claim 3 wherein the step of producing the premium quote is performed in real-time with respect to receiving the request from the client and determining the premium quote.

5. The method of claim 3 further comprising the steps of:
(a) receiving an instruction from the client to renew the selected contract for the quoted premium;
(b) updating the source system to indicate the selected contract renewed for the quoted premium; and
(c) generating a notification for the client of the competed pricing.

6. The method of claim 1 wherein the source system is a database system storing information details of a plurality of contracts for a plurality of clients.

7. The method of claim 1 wherein the contracts are facultative reinsurance contracts.

8. The method of claim 1 wherein the client is a cedent entity.

9. The method of claim 1 wherein the first parameter is at least one from the group of total insured value, retention, limit, and premium.

10. The method of claim 3 wherein the second parameter is at least one from the group of geographic location, insured value, construction, occupancy, and protection.

11. The method of claim 1 further comprising the step of updating the source system to indicate the expiring contracts that qualify for automatic pricing.

12. The method of claim 1 further comprising the steps of:
(a) for an expiring contract that does not qualify for automatic pricing, determining whether the expiring contract qualifies for manual pricing based at least in part on the first parameter; and
(b) generating a notification for the client of the expiring contract that qualifies for manual pricing.

13. The method of claim 1 further comprising the step of:
(a) for an expiring contract that qualifies for automatic pricing, including at least the following information in the notification: name of the insured, policy number, expiration date, expiring premium, and status.

14. The method of claim 3 further comprising the steps of:
(a) displaying the second parameter for the selected contract;
(b) selectively updating the information for the second parameter; and
(c) using the updated information for the second parameter in determining the premium quote.

15. The method of claim 1 further comprising the steps of:
(a) receiving approval of the determination on qualification for automatic pricing from a provider for the expiring contract; and
(b) updating the source system to indicate the expiring contract is approved for automatic pricing.

16. The method of claim 15 wherein the provider is one of a reinsurance entity, underwriter, reinsurance broker, and hub provider.

17. The method of claim 15 further for comprising the steps of:
(a) for an expiring contract approved for automatic pricing, determining a premium quote based on a second parameter included in the information;
(b) updating the source system with the premium quote for the expiring contract; and
(c) including the premium quote with the client notification of the expiring contract approved for automatic pricing.

18. The method of claim 15 further for comprising the steps of:
(a) upon receiving a request from the client, determining a premium quote for a selected one of the contracts based on a second parameter included in the information;
(b) updating the source system with the premium quote for the selected contract; and
(c) producing the premium quote for the selected contract for the client.

19. A method for insurance pricing notification using a communications network comprising the steps of:
(a) determining one or more contracts that expire within a predetermined period for a plurality of clients;
(b) storing at a location accessible through the network, a list for a client of parameters for the one or more expiring contracts associated with the client; and
(c) producing a notification for said client of the list of expiring contracts for that client using the network.

20. The method of claim 19 further comprising the step of:
(a) automatically querying a source system on a periodic basis to determine the one or more contracts that expire within a predetermined period for the plurality of clients.

21. The method of claim 19 further comprising the steps of:
(a) for an expiring contract, determining whether the expiring contract qualifies for automatic pricing; and
(b) indicating on the list whether the expiring contract qualifies for automatic pricing.

22. The method of claim 21 further comprising the steps of:
(a) determining a premium quote for the expiring contract that qualifies for automatic pricing; and
(b) including the premium quote in the list associated with the expiring contract.

23. The method of claim 19 further comprising the step of organizing the list according to the subject for each expiring contract wherein the subject is one from the group of an insured, and a risk.

24. The method of claim 19 wherein the parameters include at least one from the group of name of the insured, policy number, expiration date, expiring premium, and status.

25. A method for facilitating insurance renewal using computer communication between a client's computer and a server, comprising the steps of:
(a) in response to a first signal from the client's computer, generating a portfolio at the server for the client of one or more client contracts expiring within a predetermined period, the portfolio including pricing for renewal for the one or more expiring contracts; and
(b) in response to a second signal from the client's computer, updating the portfolio at the server to reflect renewal of any of the expiring contracts for which renewal was requested by the client.

26. The method of claim 25 further comprising the steps of:
(a) querying a source system containing information about client contracts to identify the one or more contracts expiring within the predetermined period;
(b) for an identified expiring contract, determining whether the identified contract qualifies for automatic pricing based on a first parameter included in the information; and
(c) in the portfolio, displaying an indication associated with the identified expiring contract according to the determination of qualification for automatic pricing.

27. A method for insurance renewal notification from a server to a client computer each connected to a network, the method comprising the steps of:
(a) at the server, generating a signal representing a display including at least a field identifying an expiring contract, a field indicating the status of the expiring contract, and a field reserved for indicating a new premium for the contract; and
(b) sending the signal from the server to the client computer.

28. The method of claim 27 wherein the sending step is performed in response to a request from the client computer to the provider server.

29. The method of claim 27 further comprising the step of sending at least a portion of the signal upon establishing a connection between the provider server and client computer.

30. The method of claim 27 further comprising the steps of:
(a) determining the new premium for the expiring contract; and
(b) including the new premium in the field reserve for indicating the new premium.

31. The method of claim 30 further comprising the steps of:
(a) receiving at the server a request signal from the client computer indicating a request to renew the expiring contract;
(b) renewing the expiring contract at the new premium; and
(c) sending an update signal to the client computer indicating that the expiring contract is renewed.

32. The method of claim 30 further comprising the steps of:
(a) determining whether the expiring contract qualifies for automatic pricing based on at least one parameter of the expiring contract; and
(b) if the expiring contract qualifies for automatic pricing, indicating such qualification in the signal

33. A system for facilitating insurance renewal, comprising:
a database component containing information about client contracts; and
a computer executable application that:
queries the database component for contracts that expire within a predetermined period;
filters the expiring contracts according to whether the contracts qualify for automatic pricing; and
generates a signal representing a portfolio of the expiring contracts with pricing;
the database component being updated in response to a signal received from the client or the application.

34. A system for facilitating insurance renewal, comprising:
a server connected to communicate with at least one client computer; and
a computer executable application
(i) generating a portfolio, accessible to the server, in response to a first signal from the client computer, the portfolio indicating one or more contracts expiring within a predetermined period and pricing for renewal for the one or more expiring contracts; and
(ii) updating the portfolio in response to a second signal from the client computer, the updated portfolio indicating renewal of any of the expiring contracts for which renewal was requested by the client.

35. A system for insurance renewal notification, comprising:
a server connected to a network to which at least one client's computer is also connected; and
a computer executable applications accessible through the network generating a signal representing a display including at least
(i) a field identifying an expiring contract for the at least one client,
(ii) a field indicating the status of the expiring contract, and
(iii) a field reserved for indicating a new premium for the expiring contract.

36. A system for insurance pricing notification using a computer network, comprising:
a computer executable application accessible through the network including a filtering module determining one or more contracts that expire within a predetermined period for a plurality of clients; and a notification module producing a notification for a client, the notification containing information corresponding to at least one expiring contract for that client; and
a storage device accessible through the network for storing the notification in association with an identification of the client.
